(19) United States
(12) Patent Application Publication
(10) Pub. No.: US 2008/0251464 A1
(43) Pub. Date: Oct. 16, 2008

(54) Process for Separating Solutes and Water from Aqueous Solutions with Gas Recycling

(76) Inventor: David Sevier, Surrey (GB)

Correspondence Address: KNOBBE MARTENS OLSON & BEAR LLP, 2040 MAIN STREET, FOURTEENTH FLOOR, IRVINE, CA, 92614, US

(21) Appl. No.: 12/067,360

(22) PCT Filed: Sep. 19, 2006
(86) PCT No.: PCT/GB06/50296

§ 371 Date: May 22, 2008

(30) Foreign Application Priority Data
Sep. 19, 2005 (GB) 0519087.1

(51) Int. Cl. C02F 1/00; C02F 1/20; C02F 103/08

(52) U.S. Cl. 210/712; 210/718

(57) ABSTRACT

Water can be separated from solutes in aqueous solutions by a process of forming water clathrates of gases under high pressure and low temperature conditions. The present invention outlines a series of processes where a low pressure stream of clathrate forming gas is entrained in a low pressure stream of water and carried to a region of high pressure where clathrates are formed. The clathrate crystals are then collected and separated from the solutes. The clathrate crystals are then taken to conditions that allow the clathrate to decompose to water and gas. The gas is maintained at elevated pressure and recycled to be used again as a feedstock in the process of the present invention.

The present invention relates to a process for the separation of water and solutes from aqueous solutions. More particularly, the present invention relates to a process in which the separation of water and solutes present therein is achieved via the formation of clathrates.

Water forms clathrates with various gases under certain temperature and pressure conditions. Typically clathrates are formed under conditions of high pressure and low temperature. A number of gases such as carbon dioxide, oxygen, nitrogen and hydrocarbons such as methane can form clathrates with water. Many clathrates form spontaneously and exothermally under the right conditions and will reverse spontaneously back to gas and water if exposed to low pressure and higher temperatures. Typically the energy difference between the formed clathrate and its constituent compounds is fairly small, making clathrate formation and reversal ideal for low energy desalination.

The potential of using carbon dioxide as a clathrate forming gas has been recognised previously as it is relatively inexpensive, non-toxic and not flammable. However, as yet, no viable desalination system utilising carbon dioxide as a clathrate forming gas has been realised. A water/carbon dioxide mixture generally forms clathrates below 8° C. and above pressures of 40 bar. The phase change diagram for carbon dioxide is shown in Figure one. The formation reaction for creating carbon dioxide/water clathrate is slightly exothermic at −5.68 kcal/mole (at 121K) and proceeds in the following way:

CO₂+6H₂O→CO₂.6H₂O

Previously, most of the work on clathrate formation for desalination has focused on processes that involve pumping gas or liquefied gases into water that is under pressure and is below 8° C. These processes are either batch based or are continuous but not fully recirculating. Many of the processes create high pressure by a having a long-standing column of water and delivering gas or compressed liquid gas to the pressure region where clathrates can form. The clathrates are then separated out and the process reversed with the gas potentially recaptured and reused. The water that is produced by reversing the clathrate is reduced in dissolved salts. The concentrated brine that is left from creating the clathrate is removed from the process as a waste product. A problem associated with these processes is that they require the use of expensive high pressure compression equipment for the water or the gas or both. Additionally, such equipment requires significant energy to operate. The amount of energy required increases with the pressure that is required to form the clathrate.

Previous attempts to make the desalination process more efficient have focussed upon achieving significant desalination in a single pass through the desalination process. However, this has been largely unsuccessful due to contamination of salts that are trapped between the clathrate crystals. The high cost of previous processes makes it cost prohibitive to have multiple passes though the desalination process.

It is therefore desirable to provide a continuous process for separating water and solutes from aqueous solutions via the formation of clathrates which is more reliable, energy efficient and cost effective than the prior art methods summarised above. It will also be desirable to provide such a process which is not overly reliant on expensive and/or power-consumptive equipment such as gas pressurisers and the like.

According to one aspect of the present invention, there is provided a process for the purification for separating solutes in an aqueous solution from water comprising the steps of: a) feeding a low pressure gaseous stream into an aqueous stream comprising water and solutes to form a gas/aqueous stream; b) passing the gas/aqueous stream into a clathrate formation zone to form a clathrate stream comprising clathrate and concentrated aqueous solution; c) separating the clathrate stream to produce a purified clathrate stream and a concentrated aqueous solution stream; d) converting the clathrate in the purified clathrate stream in a clathrate reversion zone to gas and water and recovering at least part of the gas produced in step d) and returning the recovered gas to the gas/aqueous stream in or before step b).

The gas/aqueous stream is passed into the clathrate formation zone by any suitable means. The clathrate formation zone is under clathrate forming conditions and the gas/aqueous stream is subjected to these conditions when it is passed therein. Clathrate formation and reversion can then be effected by only minor adjustments in the conditions to which the gas/aqueous stream are exposed. In multi-separation processes this is significantly more efficient than allowing the mixture to return to low pressures.

When the clathrate is reverted into purified water and gas, the gas is preferably prevented from reverting to atmospheric conditions. It is recycled back into the gas/aqueous stream while still near clathrate formation conditions rather than being at low pressure.

The process of the present invention can be used to separate solutes and water from aqueous solutions. It may be utilised in processes where purified water is the product of interest, such as in desalination processes, or it may be used to purify compounds dissolved in aqueous solutions via the removal of water, for example in the distillation of alcohol or in the concentration of fatty acids produced in the fermentation of organic matter.

Nevertheless, the process of the present invention is particularly well suited to the field of desalination and thus, the majority of the following description of the invention relates to that field. However, it is anticipated that the skilled artisan will appreciate how the process of the present invention could be used in alternative technical fields.

As mentioned above, it has been recognised that it is commercially unfeasible to create sufficiently desalinated water in a single pass through a clathrate separation system at an economically viable price. Advantageously, desalination can be achieved using the process of the present invention with only a single pass of the solution.

If a higher degree of desalination is required, multiple clathrate formation/reversion cycles through the process of the present invention may be performed. Although such ‘multiple pass’ processes of the prior art were unfeasible due to prohibitive costs, a further advantage of the present invention is that the cost of each pass is low and as a result, adding extra passes does not incur unbearable capital and operating costs.

This advantage is obtained as a result of the entrainment of a low pressure (i.e. at or near atmospheric pressure) clathrate forming gas stream into a flowing aqueous stream. In this way, clathrate forming gas is delivered without the use of expensive high pressure compression equipment. The entrained gas/aqueous solution mixture is then delivered to the clathrate formation zone to form the desired clathrate. This reduces the free water available, raising the concentration of solutes in the aqueous solution.

The concentrated aqueous solution and the clathrate (collectively the clathrate stream) are then separated to produce a purified clathrate stream and a concentrated aqueous stream. The purified clathrate stream is then fed into the clathrate reversion zone in which clathrate formation is reversed and the clathrate is converted into purified water and gas.

The aforementioned process could be placed in mine-shafts or in drilled holes. Salt water could then be delivered for desalination. Equally, the aforementioned process could be performed at sea using deep cold water to produce fresh water that is stored in a tanker and then delivered to land.

It is possible to entrain low pressure gas in a flowing water stream and then to compress the gas and water with a pump to the required high pressure conditions to form clathrate. This is useful for making a compact desalination plant but it is more energy intensive.

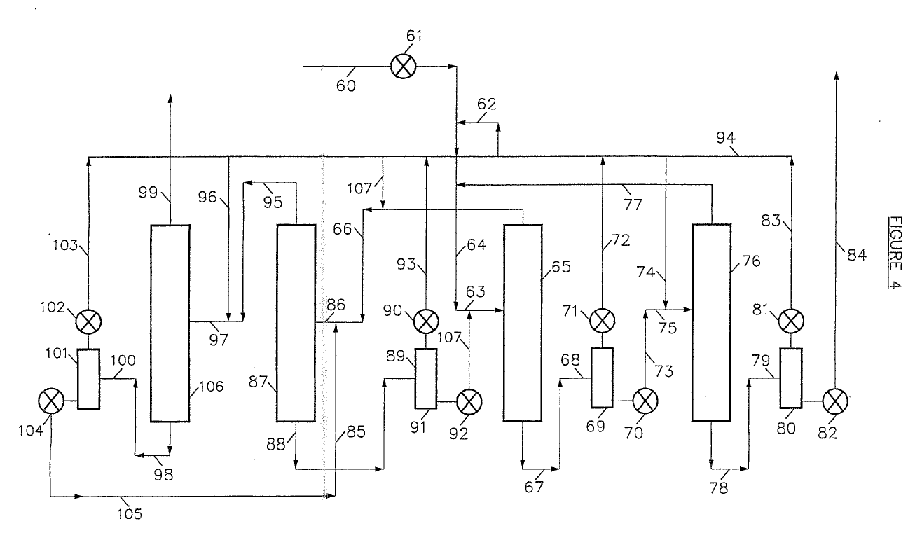

In multi-separation stage embodiments of the present invention, the concentrated aqueous solution stream produced in step c) may be fed back into the aqueous stream of step a) to allow the aqueous solution to be further concentrated. In practice, this may be realised by an arrangement in which a number of separators are positioned adjacently. The aqueous liquid extracted from the first separator can be passed through the separators to successively reduce the water content until the aqueous solution is highly concentrated and this is especially preferred where the solutes dissolved therein are to be purified and retained as opposed to being waste products. An example of such an arrangement is illustrated in FIG. 4.

Prior to separation step c), it is preferable to reduce the volume of the clathrate stream. This can be achieved by, for example, passing the clathrate stream into a separation column where the dense clathrate sinks allowing a portion of the aqueous solution to be easily removed. This solution may be fed back into the aqueous stream used in step a).

As mentioned previously, there will some situations in which multiple clathrate separations are required. In this case, gas produced from step d) is fed into a stream of water produced in step d) and the resulting gas/aqueous stream is repeatedly subjected to steps b) to d) until the resulting water stream achieves the desired level of purity.

The liquid and gas are kept either at or near the conditions of clathrate formation throughout the multiple separation processes. In this way, the changes in pressure and temperature that the liquid experiences only occur at the beginning and end of the process. In this way, energy and capital costs are minimised. Processes of the prior art have required the expenditure of significant energy to compress the gas and liquid in order to create clathrates before separating them from the concentrated aqueous solution and returning the liquid and gas to atmospheric conditions after only performing a single separation. The process of the present invention carries out multiple separations under high pressure conditions, retains the gas at high pressure and then returns the liquid back to atmospheric conditions.

Clathrate formation is exothermic and clathrate reversion is endothermic. As the clathrate formation and reversion may occur simultaneously in the process of the present invention, in a preferred embodiment, the clathrate formation zone and clathrate reversion zone are both contacted by a heat exchanger which transfers heat released during clathrate formation in the clathrate formation zone to the clathrate reversion zone to increase efficiency.

Any gas or mixture of gases may be used in the gaseous stream of step a), provided, of course, that the gas stream includes a clathrate forming gas. In a preferred embodiment, the low pressure gaseous stream fed into the aqueous stream in step a) comprises a mixture of gases which comprises clathrate forming and non clathrate forming gases. An example of a clathrate forming gas is carbon dioxide.

Where a mixture of clathrate forming and non-clathrate forming gases are used, such mixtures form positively buoyant clathrates due to small bubbles of the non-clathrate forming gas being incorporated in the clathrate. This assists in the separation of the purified clathrate stream from the concentrated aqueous solution stream as separation can be achieved without the use of mechanical separation means; separation can be achieved simply, for example, by passing the clathrate stream formed in step b) into a separation column as the clathrate, due to the presence of the non-clathrate forming gas, will be less dense than the concentrated aqueous solution and rise to the top of the chamber allowing it to be easily removed. Alternatively, if the use of mechanical separation means is preferred, slurry pumps and/or centrifuges could be used.

Various aspects of the present invention will now be more particularly described with reference to the following figures:

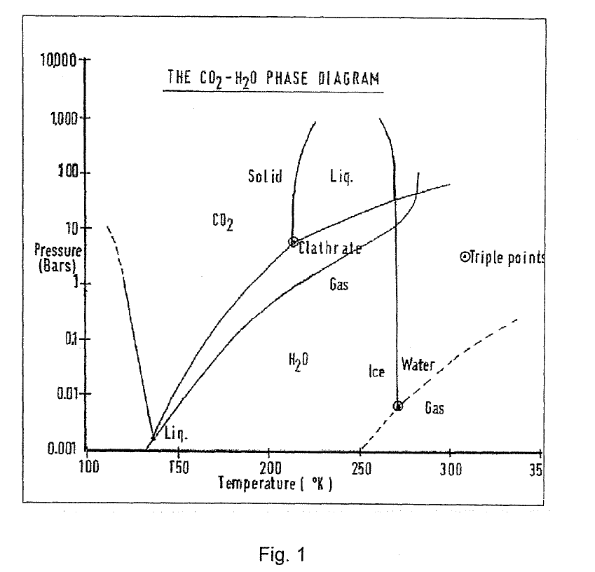

FIG. 1 is a phase change diagram for carbon dioxide/water mixtures.

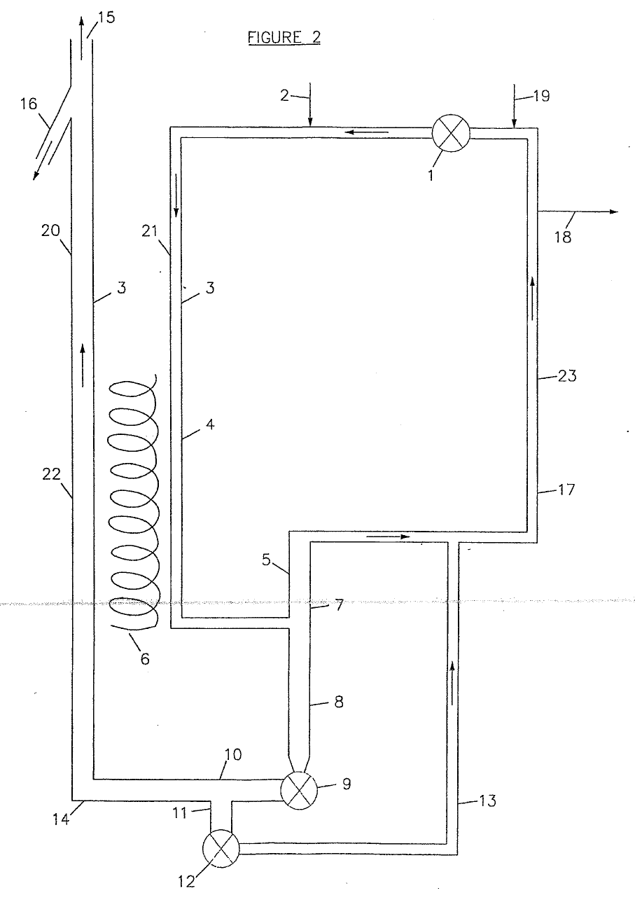

FIG. 2 is a flow diagram illustrating a single separation stage process of the present invention.

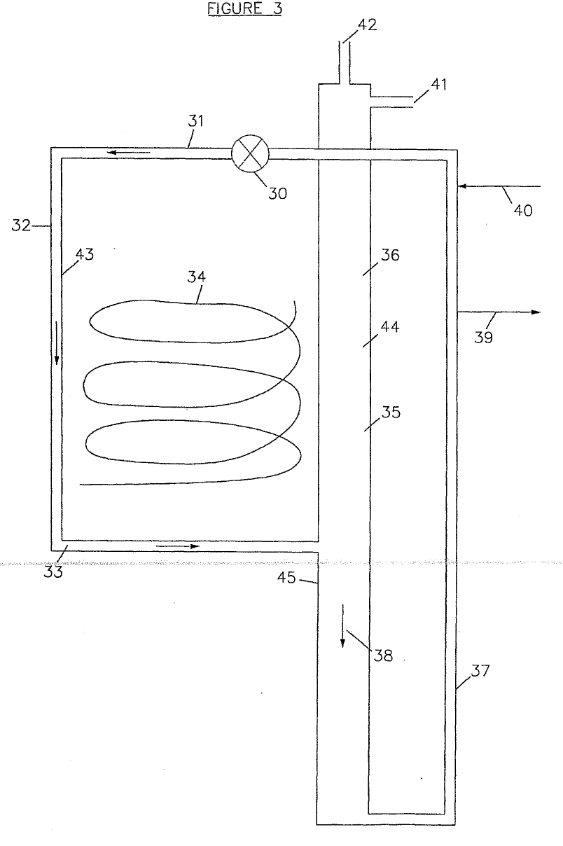

FIG. 3 is a flow diagram illustrating an alternative single separation stage process of the present invention.

FIG. 4 is a flow diagram illustrating a multiple separation stage process of the present invention.

Referring to FIG. 2, that flow diagram illustrates a ‘single pass’ embodiment of the present invention that uses flowing bubble entrainment while not requiring high-pressure compression equipment or the use of liquid compressed gases. In this arrangement, water is rapidly circulated around a circuit down to depths such that clathrates can spontaneously form and back up again to the recirculation pump (1). Carbon dioxide or another clathrate forming gas is injected (2) into the water on the discharge side of the recirculating pump (1) to produce the gas/aqueous stream. The velocity of the downwards flowing water is greater than the buoyancy of the entrained gas bubbles (3) so that the bubbles are carried down into the clathrate formation zone. The gas can be injected at pressures only slightly above that of the pressure at the top of the recirculating loop. This means that inexpensive single stage compression can be used to deliver the gas to the process. Gas could also be directly entrained by use of the venturi effect if the pressure was sufficiently low at the top of the recirculating loop.

This process brings fine bubbles (3) of gas down to the clathrate formation zone, which is under high pressure. In order to create the low temperature required for clathrate formation, there is a region (6) where heat is exchanged between the clathrate formation zone, and the clathrate reversion zone. The clathrate formation process is exothermic and releases heat that is passed to the clathrate reversion zone (20) where the clathrate (22) splits back into water and gas. Theoretically the cooling provided by the clathrate reversion reaction will exactly balance the heat created by the formation reaction. However, in practice, extra cooling or heating is likely to be required. Where the aqueous solution is warm, extra cooling of the water/gas stream may be required and where the aqueous stream is cold, extra heat may need to be inputted into the clathrate reversion zone.

The fine entrained bubbles (3) of carbon dioxide form a sinking clathrate (4), as the clathrate has a density greater than that of the surrounding water. The formed clathrate (8) falls in the separation column (7) while the remaining salty water (17) rises. Alternatively, an excess of water can be used such that when the clathrate is formed that there is an excess of water present and the salt concentration does not rise excessively.

The separation column (7) is of a greater diameter than the rising and falling pipes so that the velocity of the water slows considerably. In this way, recirculating water moves quickly in the downward (21) and upward (23) pipes but moves slowly in the separation column (7) so that the clathrate and salty water can be separated. The clathrate (8) falls to the bottom of the separation column (7) where it is collected by a slurry pump (9). Pump (12) is protected by a fine screen (11) to ensure that it only draws off the brine solution from the brine/clathrate slurry (10). The resulting clean clathrate (14) then rises up the tube to the clathrate reversion zone where it absorbs heat and decomposes to gas (15) and clean water (16). The gas (15) can be captured and reinjected to the flowing circuit. Clean water (16) is continuously drawn off at the top of the tube.

The resulting brine (17) that is created within the separation column rises via brine pipe (13) and is drawn to the smaller faster moving pipe (23) that returns the brine to pump (1). A proportion of the returning water (18) is drawn off and an equal volume of fresh salt water is added (19). The waste salt water that has a higher than usual salt concentration can be discharged back to the salt water source or it can be further concentrated in evaporation ponds to make dry salt.

In FIG. 3, an alternative embodiment is depicted. The main difference between it and the embodiment illustrated in FIG. 2 is that the input gas stream (31) comprises a mixture of gases including a gas that does not form a clathrate. An example of such a gas is nitrogen. Such mixtures form positively buoyant clathrates due to small bubbles of the extra gas being incorporated in the clathrate. To separate the positively buoyant clathrates from the concentrated aqueous solution, the separation column illustrated in FIG. 2 is inverted to collect the rising clathrate. No pump or centrifuge is needed. In the process shown in FIG. 3, as the clathrate (33) formed in tube (43) is formed, heat is transferred to clathrate reversion zone by heat transfer element (34). The clathrate (33) then enters the separation column (45) and rises up the column (45) before being collected. The denser brine (38) sinks and is passed up the rising pipe (37) to the recirculation pump (30). Brine may be removed (39) from the system to be replaced with fresh saltwater (40).

As previously mentioned, it is difficult to fully desalinate salt water in a single clathrate separation due to the trapping of salt between crystals of clathrate. An example of a multi separation process of the present invention is shown in FIG. 4. In this process, salt water (60) and entrained clathrate forming gas are delivered by pump (61) to a first clathrate formation zone (64) where clathrate formation occurs. Heat is generated and is removed by a heat exchanger which is not shown. The clathrate/salt water mixture then enters a first vertical separator (65) where the dense clathrate sinks. The clathrate is drawn from the bottom (67) of the separator (65) where the clathrate is caused to decompose to water and gas. Heat is required for this reversion and can be directly supplied or can be transferring from the heat generated during clathrate formation. Theoretically the reversion and formation reactions exactly balance each other. Waste brine from the separation process is drawn off at (66).

The clathrate can be caused to decompose in three ways by the addition of heat, by the reduction of pressure, or a combination of both. In either case, the clathrate will decompose if it is brought outside of the range that it is stable.

The clathrate is directly drawn against a filter plate with small holes (68) that is inserted into pipe (67) to prevent the clathrate directly being sucked into pumps (71, 70). The pumps create a region of low pressure in the separation chamber (69) and at the face of the clathrate slurry which is adjacent the plate (68). Heat is applied before the disk (68) to supply the energy necessary for the clathrate to decompose. The applied heat and low pressure conditions cause the clathrate to decompose to gas which is collected by pump (71) and to water which is collected by pump (70).

The captured gas passes through the pump (71) and increases in pressure. The gas is then reinjected back into the process at point (62) through a non return valve. Similarly the melted clathrate water is passed though pump (70) and returned to a pressure and temperature such that it can allow the formation of clathrate. It is then contacted with carbon dioxide (74) to form a clathrate which passes into a second vertical separator (76). It is important not to input excessive heat otherwise extra cooling will be required at (73) to return the water to a state in which clathrate can form. Where necessary, more separations can be performed to improve the purity of the water. The clathrate removed from the base of separator (76) is then passed via pipe (78) through plate (79) and into clathrate reversion chamber (80) where it is split into carbon dioxide gas and purified water. The gas is pumped out by pump (81) to line (94) and the purified water is pumped out by pump (82) to exit pipe (84). Salt water is extracted from the top of separators (65 and 76) and also from separator (87) and fed via lines (77, 66, 95) into separators (65, 87 and 106). As this happens, carbon dioxide gas from main line (94) is fed into lines (77, 65, 95) to form clathrates which then pass into the separators (65, 87, 106). The purified clathrate which is removed from the base of those separators (65, 87, 106) is passed via lines (67, 88, 98) to reversion zones (69, 91, 101) where it is separated into water which is pumped out (70, 92, 104) via lines (73, 105, 107) and gas which is pumped out (71, 90, 102) via lines (72, 93, 103).

When the water has passed through the desired number of clathrate separations, it is then returned to atmospheric pressure. The clathrate forming gas is captured and maintained at pressure. The process will steadily lose gas because some gas will remain dissolved in the water as it is returned to atmospheric pressure. Continuous input of gas into the process through flowing bubble or direct injection of pressurised gas is therefore necessary.

As the water passes through each separation stage, it will become increasingly pure. Equally, the separated brine that is removed from the top of each separator (65, 76, 87, 106) via pipes (77, 66, 95) will have a lower dissolved mineral content as compared to the stage before but higher than that of the separation stage that generates it.

It is therefore worth recovering the collected water from each stage of the process and injecting it into the beginning of the stage before. This is shown in FIG. 4 where separators (106 and 87) are fed by the brine that was removed from separators (87 and 65) respectively. Separators (106 and 87) are essentially running the separation process in reverse and are increasing the dissolved salt content as can be seen from output (99) labelled ‘concentrated brine’.

The application of the multistage process represents a significant advantage over prior processes. It allows the desalination of water from brackish aquifers where there is no opportunity to dispose of the saline discharge. By running the process to concentrate salts and to produce water that is of low salt content, the maximum amount of water is extracted from the brackish water and the waste brine that is made is concentrated such that it has a much reduced volume and can be dried readily. This would be particularly useful for locations which have brackish aquifers but which are far from the sea, such as parts of the Midwest of the United States. The inability to dispose of the waste brine makes large scale desalination impossible for areas like these. Ideally the brine could be further concentrated and converted to dry salt which could be used, for example, to salt roads in winter.

As mentioned above, the process of the present invention process will function effectively for other types of separation in addition to desalination. It can be used to reduce or concentrate the level of dissolved salts in potable water. By using multistage clathrate separation, water having a very low dissolved mineral content can be produced. This would have a number of useful applications such as for steam boiler make-up as it would cause much lower steam line corrosion (dissolved carbonates cause carbonic acid to form in steam which is highly corrosive) and lead to less scale formation within the boiler.

Alternatively, multistage clathrate separation could be used to increase the concentration of alcohol in fermented solutions such that much reduced volumes of liquid would have to be distilled to produce pure alcohol. This would be highly advantageous as distillation is very energy intensive. By reducing the volume of material that needs to be distilled, significant energy savings could be gained.

Another application for multistage clathrate separation would be to concentrate fatty acids that are produced by bacteria breakdown of sludge from waste water treatment or fermented organic matter. When organic matter ferments in a water solution, it decomposes to acidic fatty acids such as acetic acid up to a maximum concentration of approximately 10,000 ppm. The generated fatty acids are then further decomposed. If a fermenter is set up with circulation across a membrane, the diluted solution of fatty acids could be continuously extracted and passed to a cascade of multistage clathrate separators to produce a concentrated solution of fatty acids that can then be economically separated further by other means. It is currently impossible to economically concentrate the mixture of fatty acids that fermentation produces. Multistage clathrate separation can do this economically.

Multistage clathrate separation could be used to separate or concentrate many other materials from water. It offers many significant separation advantages such as low energy use and minimal temperatures of operation which can prevent unwanted chemical reactions occurring.

Multistage clathrate separation will function effectively with a number of clathrate forming gases such as methane. Carbon dioxide is particularly useful because it is nonflammable, non-toxic, safe for drinking water addition, inexpensive and readily available.

1. A process for separating solutes in an aqueous solution from water comprising the steps of:
a) feeding a low pressure gaseous stream into an aqueous stream comprising water and solutes to form a gas/aqueous stream;
b) passing the gas/aqueous stream into a clathrate formation zone to form a clathrate stream comprising clathrate and concentrated aqueous solution;
c) separating the clathrate stream to produce a purified clathrate stream and a concentrated aqueous solution stream;
d) converting the clathrate in the purified clathrate stream in a clathrate reversion zone to gas and water; and
e) recovering at least part of the gas produced in step d) and returning the recovered gas to the gaseous stream in or before step b).

2. A process according to claim 1 additionally comprising step f in which the concentrated aqueous solution stream is fed into the aqueous stream of step a) to purify the solutes dissolved therein by water removal.

3. A process according to claim 1 wherein a quantity of water is separated out from the clathrate stream prior to the subsequent separation step in step c).

4. A process according to claim 3 wherein said quantity of water is fed back into the aqueous stream of step a).

5. A process according to claim 1 wherein gas produced from step d) is fed into a stream of water produced in step d) and the resulting gas/aqueous stream is repeatedly subjected to steps b) to d) until the resulting water stream achieves the desired level of purity.

6. A process according to claim 5 wherein the gas/aqueous stream is maintained at or near clathrate forming conditions so that clathrate formation and reversion can be effected by only minor adjustments in the conditions to which the gas/aqueous stream are exposed.

7. A process according to claim 1, wherein the low pressure gaseous stream comprises a mixture of gases which comprises clathrate forming gas and non clathrate forming gas.

8. A process according to claim 7 wherein the clathrate forming gas in the low pressure gaseous stream is carbon dioxide and the non-clathrate forming gas in the low pressure gaseous stream is nitrogen.

9. A process according to claim 1, wherein the process is used to desalinate salt water.

10. A process according to claim 1, wherein the process is used to separate fatty acids from water.

11. A process according to claim 1, wherein to separate alcohol from water.

12. (canceled)
